(19) United States
(12) Patent Application Publication
(10) Pub. No.: US 2001/0002352 A1
(43) Pub. Date: May 31, 2001

(54) Shadow mask structure and color CRT

(75) Inventors: Kiyofumi Mizuta, Shiga (JP); Hiroshi Hasegawa, Shiga (JP)

Correspondence Address: HELFGOTT & KARAS, P.C., 60th Floor, Empire State Building, New York, NY, 10118-0110, US

(73) Assignee: NEC CORPORATION

(21) Appl. No.: 09/725,625

(22) Filed: Nov. 29, 2000

(30) Foreign Application Priority Data
Nov. 30, 1999 (JP) 339834/1999

(51) Int. Cl. H01J 9/02

(52) U.S. Cl. 445/35

(57) ABSTRACT

In a shadow mask structure, mounting holes are provided on two sides of a shadow mask to which tension is not applied, and a vibration-absorbing body is loosely engaged in these mounting holes.

### BACKGROUND OF THE INVENTION

1. Field of the Invention

The present invention relates to a shadow mask for a color CRT, and more particularly to a shadow mask having a structure in which a shadow mask is tensioned in only one direction, and to a color CRT that uses a shadow mask of this construction.

2. Related Art

In recent years, there has been an increase of products in so-called flat color CRTs, in which the glass panel surface is substantially flat. FIG. 13 shows a partial cross-sectional perspective view of a glass panel 130 for use in a flat CRT. In this drawing, the reference numeral 131 is a glass panel surface (outside of the color CRT), and 132 is the glass panel inner surface (inside of the color CRT) . As shown in this drawing, even if the glass panel surface 131 is substantially flat, the thickness of the glass cross-section is greater toward the periphery than at the center, and the glass panel 130 has the shape of a concave lens that forms a part of a cylinder. The first reason for this is that, if the glass at the periphery were to be the same as at the center, the withstanding pressure of the glass bulb would become low, and because there is a great danger of implosion in a color CRT. The second reason is that, if the glass at the periphery is the same as that at the center, the image will appear to have an unnatural pinching effect. To prevent implosion and impart an appearance of flatness to the image, the glass thickness is made greater toward the periphery.

Because as noted above the glass panel inner surface 132 has the shape of a concave lens that forms a part of a cylinder, a shadow mask of the past was accordingly made with a constant radius of curvature that was substantially congruent with the glass panel inner surface 132. This will be referred to hereinafter as a cylindrical shadow mask.

FIG. 14 is a perspective view of a shadow mask structure 140 of the past. In this drawing, the reference numeral 141 is a mask frame, 142 is a shadow mask, 142A is a shadow mask welding point, and 142B is the holed part of the shadow mask 142.

Tension is applied to the shadow mask 142 from only two sides of the mask frame 141, via the shadow mask welding points 142A. Because it is difficult to apply tension to a cylindrical shadow mask from four directions, tension is usually applied in this manner from two sides only.

Problems accompanying the shadow mask structure 140 of the past are described below with reference to FIG. 15, which is a plan view of a shadow mask 142 of a shadow mask structure 140 of the past. In this drawing, the reference numeral 142B is the holed part, 142C is a non-holed part, and 142D is an electron beam passage hole. The approximate dimensions of the shadow mask 142, for the case of a 19-inch color CRT are long sides of approximately 370 mm, short sides of approximately 280 mm, and a thickness of 0.1 mm. The non-holed part 142C has a width of 4 mm on one side.

As noted above, because tension is applied to the shadow mask 142 from only two sides (the top and bottom sides in FIG. 15), the two sides perpendicular thereto (the left and right sides in FIG. 15) are free. As noted above, in spite of vertical and horizontal dimensions of the shadow mask of approximately 280 mm and 370 mm, respectively, the thickness is only 0.1 mm, so that it is not a rigid body. For this reason, if it is subjected to vibration from, for example, a speaker, the shadow mask 142 resonates in the region of two free sides thereof, and vibrates.

According to an experiment by the inventors, in a shadow mask structure 140 of the past with two sides of the shadow mask 142 free, a single large shock results in a vibration having a duration of approximately 60 to 120 seconds. Because the electron beam passage hole 142D of the shadow mask 142 is offset from its usual position during vibration of the shadow mask 142, there is a decrease in color purity. Therefore, in a color CRT with a shadow mask structure 140 of the past, there was often the problem of a loss of color purity at the left and right sides of the screen.

For solving such problems, many sorts of vibration-preventing structures have been devised. Among them, we will introduce several typical structures. The term such as Japanese Unexamined Patent Application Publication No. is abbreviated by JPA, Laid-open No..

Cited reference (1);JPA, Laid-open No.8-77936

The cited reference (1) is concerned with a color cathode-ray tube having a lightweight and high-quality slot type shadow mask by which vibration of the shadow mask is restrained by bringing vibration damping bodies into contact with non-perforated parts on both ends of the shadow mask extended on a mask frame.

In a color cathode-ray tube, a mask frame body structure has a bar supported with arms. One end of a suspension spring is fixed to the arms. One end of almost T-shaped vibration damping bodies are fixed to these arms, and a T-shaped head part is arranged so as to come into contact with the end side of a slot type shadow mask. A base-plate is fixed to the bar. When impact is applied to the shadow mask, vibration of a grille reaches non-perforated parts around the shadow mask by the existence of bridges. The vibration is damped by the vibration damping bodies coming into contact with these non-perforated parts.

Cited reference (2);JPA, Laid-open No.9-274867

The cited reference (2) is concerned with a color cathode-ray tube which reduces the surface vibration generated in a shadow mask, and prevents the generation of color displacement by making a vibration damper abut on each edge crossing the electron beam scanning direction of the shadow mask.

Electron beam emitted from each electron gun of an electron gun structure is scanned by the drive of a deflecting yoke arranged in the periphery of a part of a funnel part, which is close to a neck part. A vibration damper, which is supported by an arm, is made to abut on each edge parallel with the direction (y) of the shadow mask. With this structure, even in the case where surface vibration is generated in the shadow mask, the vibration is quickly reduced by the vibration damper.

Cited reference (3);JPA, Laid-open No.9-274868

The cited reference (3) is concerned with a color cathode-ray tube which quickly damps the surface vibration generated in a shadow mask, and prevents the generation of color displacement by making a vibration damper abut on a shadow mask at multiple points.

In this cited reference (3), vibration damper, which is arranged along edges of a shadow mask, is made to abut on a surface of an electron gun structure side of each edge parallel with the direction (g) of a shadow mask. The vibration damper is supported by a supporting board fixed to an arm so that abutment on the shadow mask is held. In this case, the vibration damper is made to abut on the shadow mask at multiple points. As a result, even in the case where surface vibration is generated in the shadow mask, the vibration is quickly damped by the vibration damper.

As a method to solve the above-noted problems, there are vibration-preventing structures in which a T-shaped, Z-shaped, or coil-spring-shaped vibration-attenuating body is brought into contact with the two free sides of a shadow mask, these structures being disclosed in the above three cited references (1) to (3), respectively. However, with the structures disclosed therein, it is necessary to fabricate a vibration-attenuating body having a complex shape, and to assemble this vibration-attenuating body to the shadow mask with high accuracy, so that the shadow mask does not deform. For this reason, these approaches are accompanied by an increase in parts costs, assembly costs, and an increase in the weight of the shadow mask structure.

Additionally, although slightly different from the structure of a shadow mask, an aperture grill having a color-selection function is disclosed in Japanese Unexamined Patent Application Publication No.10-106449, in which vibration is prevented by affixing a damper line that transversely crosses over the surface of the aperture grill. Applying this, it is possible to affix a damper line to the surface of a shadow mask to prevent vibration. However, in an aperture grill as well, and in a shadow mask, because the shadow of the damper line appears on the screen, this is particularly undesirable in the case of a color CRT for use as a high-accuracy display.

In the -shadow mask structure of the present invention, a vibration-absorbing body is mounted to the two sides of the shadow mask that tend to vibrate, which are not tensioned. The vibration energy of the shadow mask is quickly lost by the friction between the vibration-absorbing body and the shadow mask, so that it is possible to attenuate the vibration of the shadow mask to a level at which there is no practical problem with regard to a loss of color purity.

The above-noted vibration-absorbing body is a simple component that is lightweight and which does not require accuracy in mounting, featuring low parts cost and assembly cost. Therefore, by providing the shadow mask structure of the present invention, it is possible to achieve a color CRT with low cost, light weight, and a high-quality display.

### SUMMARY OF THE INVENTION

To achieve the above-noted object, a shadow mask structure according to the present invention has mounting holes on the non-holed part on the two sides to which tension is not applied, and a vibration-absorbing body loosely engaged in this mounting holes.

Specifically, a first aspect on the present invention is a shadow mask structure having a mask frame with a substantially rectangular outer frame, and a shadow mask that is substantially rectangular and is provided on the mask frame, and that ends portion of the shadow mask is provided onto a pair of long sides of the mask frame so that the mask is tensioned by the long sides. This shadow mask structure has mounting holes on at least one of the short-sides of the shadow mask, and a vibration-absorbing bodies which are loosely engaged in the mounting holes. A part of the vibration-absorbing body that is in contact with the mounting holes has a bladed portion capable of completely covering the mounting hole.

In a second aspect of the present invention, the vibration-absorbing body has a configuration in that at least two disk- shaped blade-like portions are provided at both ends of a substantially cylindrical body.

In a third aspect of the present invention, the vibration-absorbing body is substantially a U-shaped cylindrical body, with a substantially disc-shaped bladed portion provided at both ends of said U-shaped cylindrical body.

In a fourth aspect of the present invention, the vibration-absorbing body is substantially ring-shaped cylindrical body with a bladed portion, wherein at an intermediate portion of the substantially ring-shaped cylindrical body, there is a substantially disc-shaped bladed portion.

In a fifth aspect of the present invention, the vibration-absorbing body is opened gate-shaped with a bladed portion, wherein at an intermediate portion of the substantially opened gate-shaped cylinder, which is open at both ends, there is a bladed portion that is substantially disc-shaped.

In a sixth aspect of the present invention, the material of the mask frame is 13-chromium stainless steel, the material of the shadow mask is Invar, and the material of the vibration-absorbing body is 18-8 stainless steel.

A seventh aspect of the present invention is a shadow mask structure having a mask frame having a substantially rectangular outer frame;, a shadow mask that is substantially rectangular, a pair of mask-supporting bodies formed on a pair of longer sides of the mask frame, wherein each of long side portions of the shadow mask is contacted to each one of said pair of long side forming said mask—supporting bodies so as to give tension to said shadow mask to form a shadow mask structure; mounting holes provided at short sides in the shadow mask; and a vibration-absorbing body loosely engaged in the mounting holes, the vibration-absorbing body being provided with a blade-like portion at a part that comes into contact with the mounting holes, and the blade-like portions being capable of completely covering the mounting holes.

In an eighth aspect of the present invention, the vibration-absorbing body is having a configuration in that at least two disk-shaped blade-like portions are provided at both ends of a substantially cylindrical body..

In a ninth aspect of the present invention, the vibration-absorbing body is substantially a U-shaped cylindrical body, with a substantially disc-shaped bladed portion provided at both ends of the U-shaped cylindrical body.

In a tenth aspect of the present invention, the vibration-absorbing body is substantially a ring-shaped cylindrical body with a blade, wherein at an intermediate portion of said substantially ring-shaped cylindrical body, there is a substantially disc-shaped bladed portion.

In an eleventh aspect of the present invention, the vibration-absorbing body is gate-shaped with a blade, wherein intermediate in the substantially gate-shaped cylinder, which is open at both ends, there is a bladed portion that is substantially disc-shaped.

In a twelve aspect of the present invention, the material of the mask frame is 13-chromium stainless steel, the material of the shadow mask is Invar, and the material of the vibration-absorbing body is 18-8 stainless steel.

A thirteenth aspect of the present invention is a color CRT having a shadow mask structure according to anyone of the first through twelfth aspects of the present invention.

### BRIEF DESCRIPTION OF THE DRAWINGS

FIG. 1 is a perspective view of a shadow mask structure according to a first embodiment of a present invention.

FIG. 2 is an enlarged view of the region of a vibration-absorbing body of a shadow mask structure according to the first embodiment of the present invention, and a cross-sectional view thereof.

FIG. 3 is a perspective view of a shadow mask structure according to a second embodiment of a present invention.

FIG. 4 is an enlarged view of the region of a vibration-absorbing body of a shadow mask structure according to the second embodiment of the present invention, and a cross-sectional view thereof.

FIG. 5 is a perspective view of a shadow mask structure according to a third embodiment of a present invention.

FIG. 6 is an enlarged view of the region of a vibration-absorbing body of a shadow mask structure according to the third embodiment of the present invention, and a cross-sectional view thereof.

FIG. 7 is a perspective view of a shadow mask structure according to a fourth embodiment of a present invention.

FIG. 8 is an enlarged view of the region of a vibration-absorbing body of a shadow mask structure according to the fourth embodiment of the present invention, and a cross-sectional view thereof.

FIG. 9 is a perspective view of a shadow mask structure according to the fifth embodiment of the present invention.

FIG. 10 is a perspective view of a shadow mask structure according to the sixth embodiment of the present invention.

FIG. 11 is a perspective view of a shadow mask structure according to the seventh embodiment of the present invention.

FIG. 12 is a perspective view of a shadow mask structure according to the eight embodiment of the present invention.

FIG. 13 is a partial perspective cross-sectional view of a glass panel for a flat CRT.

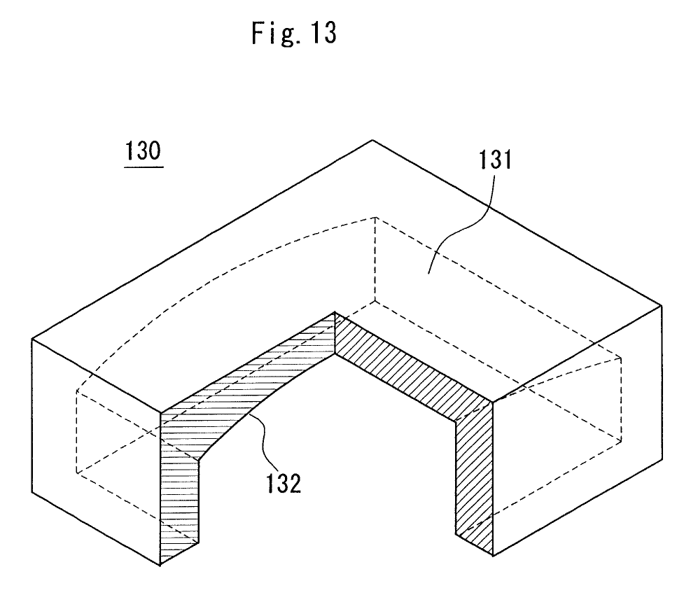

FIG. 14 is a perspective of a shadow mask structure of the past.

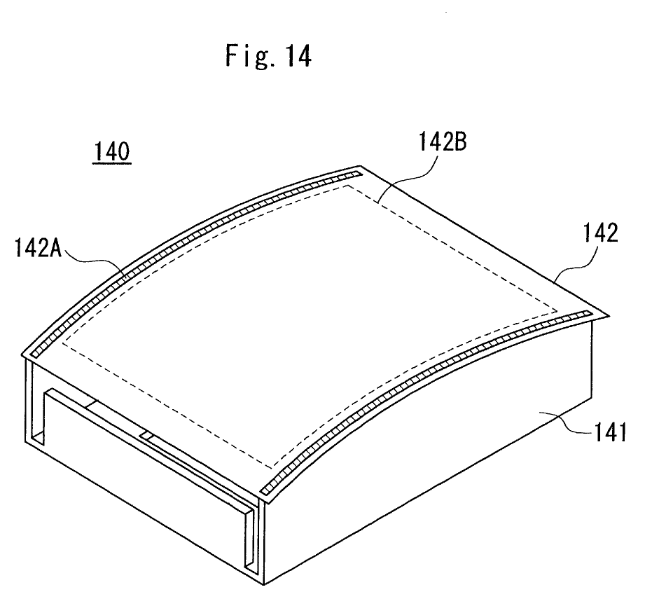

FIG. 15 is a plan view of a shadow mask having a shadow mask structure of the past.

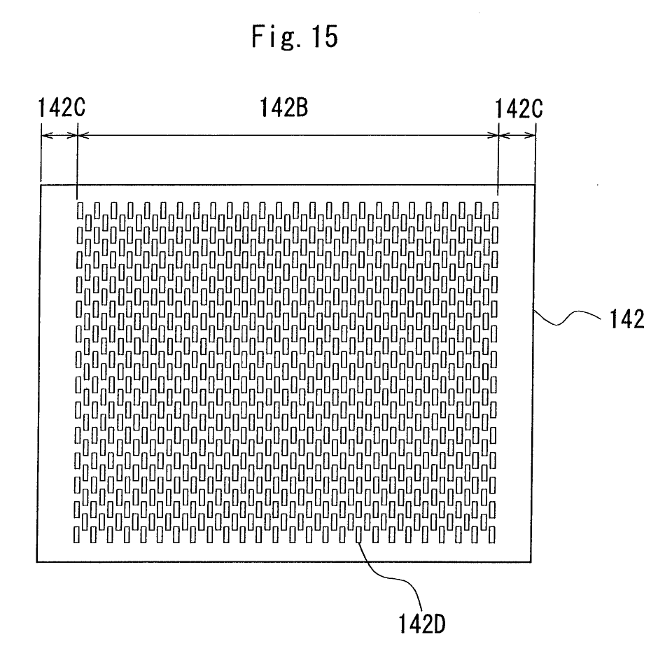

### DETAILED DESCRIPTION OF THE PREFERRED EMBODIMENTS

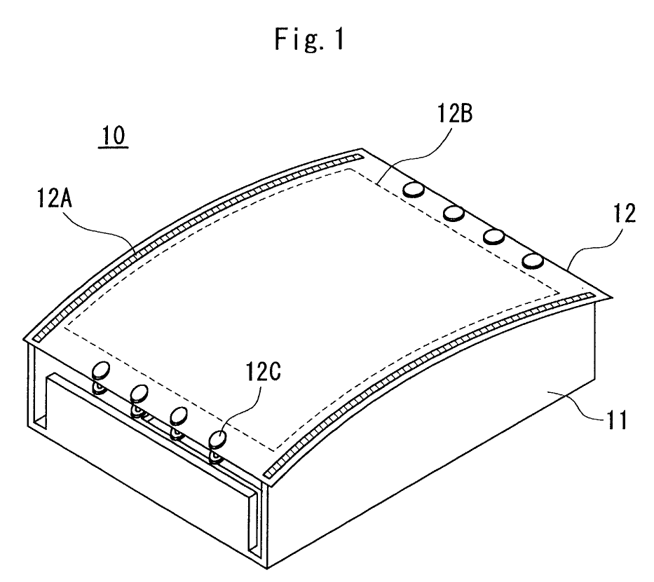

Embodiments of a shadow mask structure according to the present invention are described in detail below, with references made to relevant accompanying drawings. FIG. 1 is a perspective view of a shadow mask structure 10 according to a first embodiment of the present invention. In this drawing, the reference numeral 11 denotes a mask frame, 12 is a shadow mask, 12A is a shadow mask welding part, 12B is a holed part of the shadow mask 12, and 12C is a vibration-absorbing body.

The shadow mask 12 has tension applied to it from two sides (long sides) of the mask frame 11, via the shadow mask welding parts 12A.

The mask frame 11 is made of 13 chromium stainless steel that is 2.2 mm thick and the shadow mask 12 is made of Invar that is 0.1 mm thick. The dimensions of the shadow mask structure 10 are long sides of 360 mm, short side lengths of 270 mm, a height of 43 mm, and this shadow mask is for used in a 19-inch color CRT.

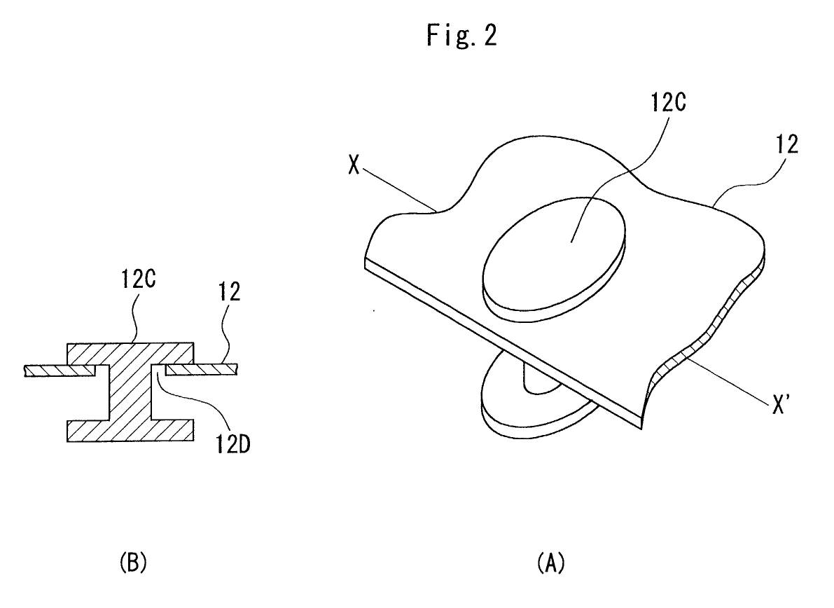

FIG. 2 shows an enlarged view in the region of the vibration-absorbing body 12C provided in the shadow mask structure 10 of the first embodiment of the present invention, and the X-X′ cross-sectional view thereof. The method of mounting the vibration-absorbing body 12C is as follows. First, cylindrical 18-8 stainless steel members with a diameter of 1 mm and a length of 5 mm are prepared, these serving later as the vibration-absorbing bodies 12C. Mounting holes 12D having a diameter of 1.8 mm are formed in the non-holed parts of the shadow mask 12. The cylindrical stainless steel members are passed through the mounting hole 12D and both ends thereof are swaged, so as to form disc-shaped tongues on both ends, having a diameter of 3.5 mm. In this manner, wheel-shaped vibration-absorbing bodies 12C with disc-shaped tongues on both ends thereof are mounted to non-holed parts of shadow mask 12.

It is important that the vibration-absorbing bodies 12C be loosely mounted to the shadow mask 12. For this reason, when the shadow mask 12 vibrates, the vibration-absorbing bodies 12C are free to move inside the mounting holes 12D, and the shafts of the vibration-absorbing bodies 12C and the side walls of the mounting holes 12D rub up against one another, so that the vibrational energy is change to frictional energy, thereby quickly attenuating the vibration of the shadow mask 12.

According to an experiment performed by the inventors, when the vibration-absorbing bodies 12C are loosely mounted as noted above, compared with the shadow mask structure 140 of the past, with the shadow mask structure 10 according to the first embodiment of the present invention, the amplitude with respect to the same size of shock is reduced to approximately one-half and the attenuation time is approximately ⅙(approximately 10 seconds). If the vibration is reduced to this degree, it is almost impossible to perceive a lost of color purity on the display screen. However, if the mounting holes 12D are made small so that the vibration-absorbing bodies 12C cannot move freely, amplitude and attenuation time are both not very different from those of a shadow mask structure 140 of the past, and the effectiveness of mounting the vibration-absorbing bodies 12C is lost. Therefore, it is essential that the vibration-absorbing bodies 12C move freely within the mounting holes 12D.

In order for the vibration-absorbing bodies 12C to move freely within the mounting holes 12D, if the diameter of the shafts of the vibration-absorbing bodies 12C is d (mm), it is appropriate that the mounting holes 12D have a diameter of 1.2 d (mm) to 3 d (mm).

Additionally, because the shafts of the vibration-absorbing bodies 12C rub up against the side walls of the mounting holes 12D, so that vibrational energy is converted to frictional energy, to improve the efficiency of this conversion, it is desirable that the shafts of the vibration-absorbing bodies 12C be rough-surfaced rather than a mirror-finish surface.

Because there is a temperature rise to approximately 500° C. in the process of manufacturing a color CRT, the vibration-absorbing bodies 12C must be made of a material that can withstand this temperature. It should also be noted that rusting of the vibration-absorbing bodies 12C would be a cause of trouble. For this reason, it is appropriate that the material of the vibration-absorbing bodies 12C be 18-8 stainless steel, which is resistant to rust, easily available, and low in cost.

Additionally, the tongues at both ends of the vibration-absorbing bodies 12C must be formed with a size that enables complete coverage of the mounting holes 12D. The reason for this is as follows. As is well-known, the shadow mask 12 is used as an exposure mask in the process of forming a pattern on the black matrix. If there were to be a part of the mounting holes 12D that is not covered, this would pass ultraviolet light, so that a hole would be formed in that part of the black matrix film, thereby resulting in a bright point in the black part in the surrounding area of the CRT screen. This would reduce the value of the color CRT as a product. I is therefore necessary that the tongues at both ends of the vibration-absorbing bodies 12C be formed with a size and shape that enables complete coverage of the mounting holes 12D, and that care is taken that during the black matrix exposure process, the tongues of the vibration-absorbing bodies 12C cover the mounting holes 12D completely.

In the shadow mask structure 10 according to the first embodiment of the present invention, as shown in FIG. 1, there are four vibration-absorbing bodies 12C mounted toward the center part at the left and right sides of the shadow mask 12. This is because, even if the left and right side of the shadow mask 12 are in the free condition, there is a tendency for the part near the shadow mask welding parts 12A not to vibrate, so that the mounting is done closer to the center part that tends more to vibrate. However, it is desirable that the mounting position and appropriate number of vibration-absorbing bodies 12C to be mounted be determined experimentally for each shadow mask structure.

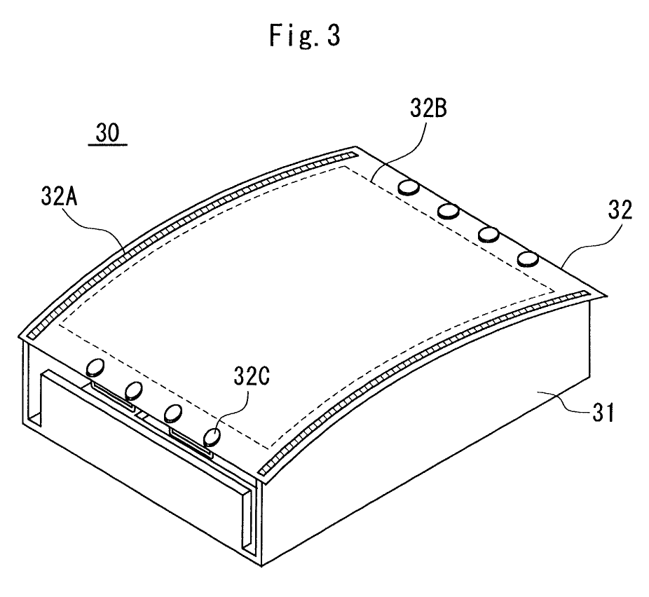

FIG. 3 is a perspective view of a shadow mask structure 30 according to a second embodiment of the present invention. In this drawing, the reference numeral 31 denotes a mask frame, 32 is a shadow mask, 32A are shadow mask welding parts, 32B is the holed part of the shadow mask 32, and 32C are vibration-absorbing bodies.

The shadow mask 32 has tension applied to it from two long sides of the mask frame 31, via the shadow mask welding part 32A. The material and dimensions of the mask frame 31 and shadow mask 32 are the-same as described for the shadow mask structure 10 according to the first embodiment.

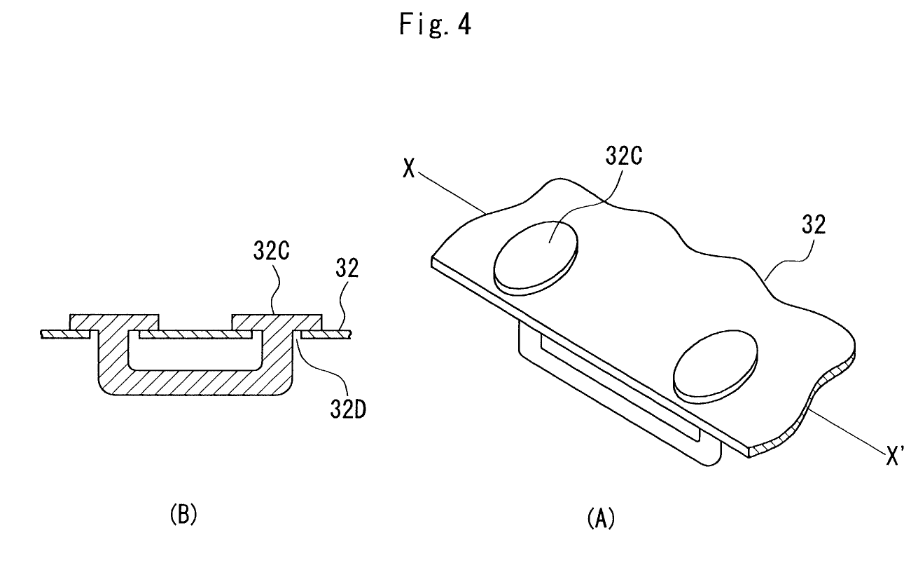

FIG. 4 is an enlarged view of the region of the vibration-absorbing body 32C provided in the shadow mask structure 30 according to the second embodiment, and an X-X′ cross-sectional view thereof. The method of mounting the vibration-absorbing bodies 32C is as follows. First, a U-shaped 18-8 stainless steel member having two sides of length 5 mm, a long side of length 10 mm joining the two sides, and a diameter of 1 mm is prepared, this to serve as the vibration-absorbing body 32C. In a non-holed part of the shadow mask 32, two mounting holes 32D having diameters of 1.8 mm are formed at a spacing of 10 mm therebetween. The U-shaped stainless steel member is passed through the mounting holes 32D and the ends thereof are swaged to form tongues at each end having a diameter of 3.5 mm. In this manner, the U-shaped vibration-absorbing body 32C having disc-shaped tongues on the ends thereof is loosely mounted to the non-holed part of the shadow mask 32.

The mechanism of rapidly attenuating the vibration of the shadow mask 32 by means of the vibration-absorbing bodies 32C is the same as described with regard to the shadow mask structure 10 according to the first embodiment. According to an experiment performed by the inventors, the vibration-attenuating effect of the shadow mask 30 of the second embodiment is almost the same as the case of the shadow mask structure 10 of the first embodiment.

In order for the vibration-absorbing bodies 32C to freely move within the mounting holes 32D, if the diameter of the shaft of the vibration-absorbing body 32C is d (mm), it is appropriate for the mounting hole 32D diameter to be 1.2 d (mm) to 3 d (mm).

The material of the vibration-absorbing body 32C, for the same reason as described for the vibration-absorbing bodies 12C of the shadow mask structure 10 of the first embodiment is appropriately made 18-8 stainless steel. Additionally, the size and shape of the tongues of the vibration-absorbing bodies 32C must be made such that it is possible to completely cover the mounting holes 32D, in the same manner as described with regard to the vibration-absorbing bodies 12C of the shadow mask structure 10 of the first embodiment.

The advantage of the vibration-absorbing body 32C of the shadow mask structure 30 of the second embodiment over the vibration-absorbing body 12C of the shadow mask structure 10 of the first embodiment is that it is only necessary to form one-half of the number of tongues.

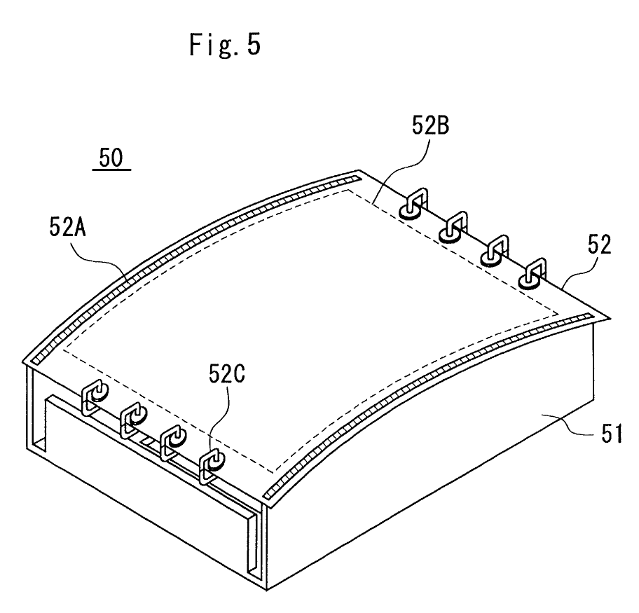

FIG. 5 is a perspective view of a shadow mask structure 50 according to a third embodiment of the present invention. In this drawing, the reference numeral 51 denotes a mask frame, 52 is a shadow mask, 52A are shadow mask welding parts, 52B is a holed part of the shadow mask 52, and 52C are vibration-absorbing bodies.

The shadow mask 52 has tension applied to it from two long sides of the mask frame 51, via the shadow mask welding parts 52A. The material and dimensions of the mask frame 51 and shadow mask 52 are the same as the shadow mask structure 10 of the first embodiment.

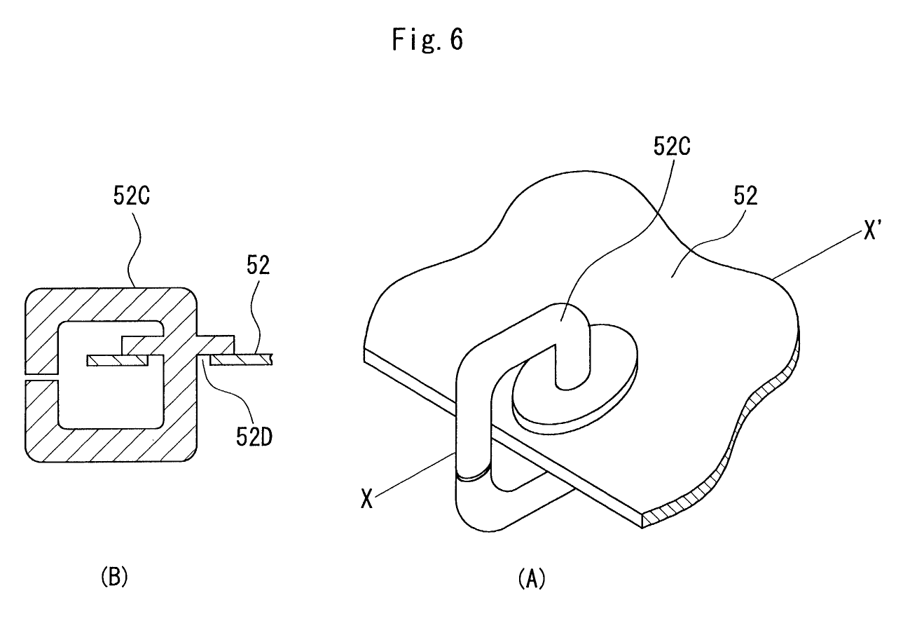

FIG. 6 is an enlarged view of the region of vibration-absorbing body 52C provided in the shadow mask structure 50 of the third embodiment, and X-X′ cross-sectional view thereof.

The method of mounting the vibration-absorbing bodies 52C is as follows. First, an 18-8 stainless steel member that is a cylinder having a diameter of 1 mm and a length of 20 mm, with a disc-shaped tongue having a diameter of 3.5 mm at a position of approximately ⅓from the end thereof is prepared, this serving later as the vibration-absorbing body 52C. The disc-shaped tongue can be formed by pinch processing of a cylinder, and it is alternatively possible to form this by a disc-shaped member with a hole, through which a cylinder is passed and swaged. A mounting hole 52D having a diameter of 1.8 mm is formed in the non-holed part of the shadow mask 52. The stainless steel member with a tongue is pass through the mounting hole 52D, and the cylindrical part thereof is bent into a ring shape, so that the ends thereof abut. Thus, the ring-shaped vibration-absorbing body 52C with an intermediate disc-shaped tongue is loosely mounted to the non-holed part of the shadow mask 52.

The mechanism of quickly attenuating vibration in the shadow mask 52 by means of the vibration-absorbing body 52C is the same as was described for the shadow mask structure 10 of the first embodiment. An experiment performed by the inventors indicates that the vibration-attenuating effect of the shadow mask 50 of the third embodiment is almost the same as the case of the shadow mask structure 10 of the first embodiment.

In order for the vibration-absorbing body 52C to freely move within the mounting hole 52D, for a shaft dimension d (mm) of the vibration-absorbing body 52C, it is appropriate that the diameter of the mounting hole 52D be 1.2 d (mm) to 3 d (mm).

The material of the vibration-absorbing bodies 52C is appropriately made 18-8 stainless steel, for the same reason as in the case of the vibration-absorbing bodies 12C of the shadow mask structure 10 of the first embodiment. The fact that the size and shape of the tongue of the vibration-absorbing body 52C must be such that it can completely cover the mounting hole 52D is the same as for the case of the vibration-absorbing body 12C of the shadow mask structure 10 of the first embodiment.

The advantage of the vibration-absorbing body 52C of the shadow mask structure 50 of the third embodiment compared to the vibration-absorbing body 12C of the shadow mask structure 10 of the first embodiment is that, because the tongue is formed beforehand, it is not necessary to form the tongue after passing the vibration-absorbing body through the shadow mask. Although there is a danger of deforming or damaging the shadow mask when the vibration-absorbing body is passed therethrough, this danger is eliminated by forming the tongue beforehand. Additionally, the vibration-absorbing body, being processable before mounting to the shadow mask, is applicable to automated production, and facilitates a reduction in costs.

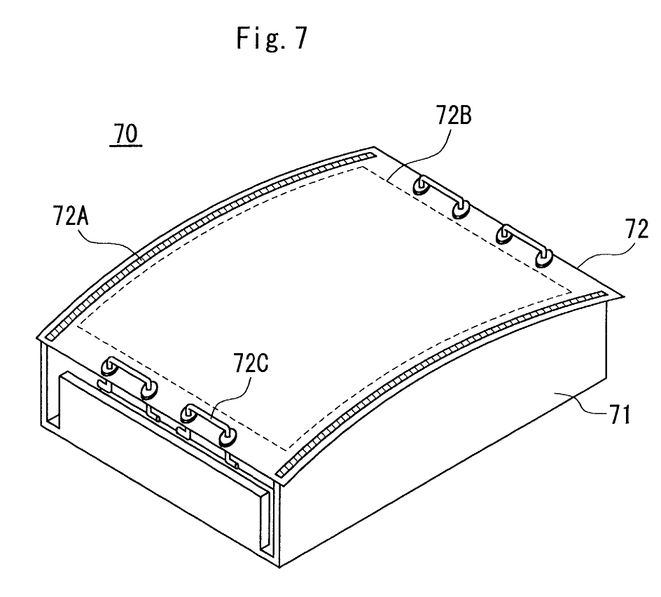

FIG. 7 is a perspective view of a shadow mask structure 70 according to a fourth embodiment of the present invention. In this drawing, the reference numeral 71 denotes a mask frame, 72 is a shadow mask, 72A are shadow mask welding parts, 72B is a holed part of the shadow mask 72, and 72C are vibration-absorbing bodies.

The shadow mask 72 has tension applied to it from two long sides of the mask frame 71, via the shadow mask welding parts 72A. The material and dimensions of the mask frame 71 and the shadow mask 72 are the same as the shadow mask structure 10 of the first embodiment.

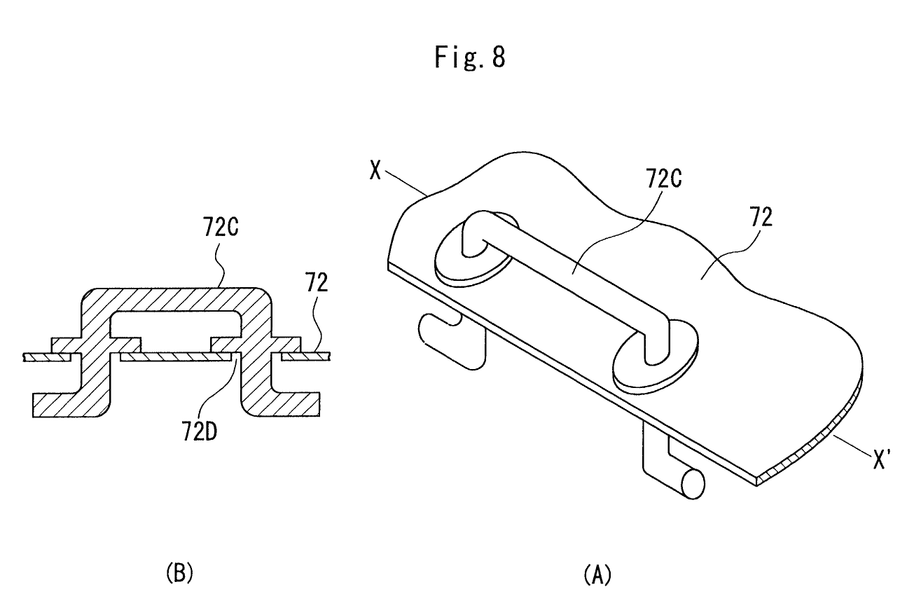

FIG. 8 is an enlarged view of the region of the vibration-absorbing body 72C provided in the shadow mask structures 70 of the fourth embodiment, and an X-X′ cross-sectional view thereof.

The method of mounting the vibration-absorbing body 72C is as follows. First, an 18-8 stainless steel member that will serve as the vibration-absorbing body 72C, and which has two sides of length 10 mm and diameter of 1 mm at each end thereof and a long side having a length of 10 mm connecting the sides into a U-shaped cylinder further having a 3.5-mm-diameter disc-shaped tongues at positions approximately 7 mm from the ends thereof. The disc-shaped tongues can be formed by pinch processing, and it is alternatively possible to form this by a disc-shaped member with a hole, through which a cylinder is passed and swaged. Mounting holes 72D of diameter 1.8 mm and 10 mm apart are formed in the non-holed part of the shadow mask 72. The U-shaped stainless steel member with tongues is passed through the mounting holes 72D and the ends thereof are bent into L-shapes. In this manner, the vibration-absorbing body 72C, shaped as a gate with the ends open and having a disc-shaped tongue intermediate therein is loosely mounted to the non-holed part of the shadow mask 72.

The mechanism of quickly attenuating vibration in the shadow mask 72 by means of the vibration-absorbing bodies 72C is the same as in the case of the shadow mask structure 10 of the first embodiment. An experiment by the inventors indicates that the vibration-attenuating effect of the shadow mask 70 of the fourth embodiment is almost the same as the case of the shadow mask structure 10 of the first embodiment. In order to allow the vibration-absorbing body 72C to freely move within the mounting hole 72D, with a shaft diameter d (mm) of the vibration-absorbing body 72C, it is appropriate that the diameter of the mounting hole 72D be 1.2 d (mm) to 3 d (mm).

The material of the vibration-absorbing body 72C, for the same reason as in the case vibration-absorbing body 12C of the shadow mask structure 10 of the first embodiment, is appropriately made 18-8 stainless steel. The fact that the size and shape of the tongues of the vibration-absorbing bodies 72C must be such that it is possible completely cover the mounting holes 72D is the same as in the case of the vibration-absorbing body 12C of the shadow mask structure 10 of the first embodiment.

The advantage of the vibration-absorbing body 72C of the shadow mask structure 70 of the fourth embodiment over the vibration-absorbing body 32C of the shadow mask structure 30 of the second embodiment is that, because the tongues are formed beforehand, it is not necessary to form them after passing the vibration-absorbing body through the shadow mask. An advantage of the vibration-absorbing body 72C of the shadow mask structure 70 of the fourth embodiment in comparison to the vibration-absorbing body 52C of the shadow mask structure 50 of the third embodiment is that, because it is not necessary to accurately abut the ends when the ends are bent, it is not necessary to achieve bending accuracy.

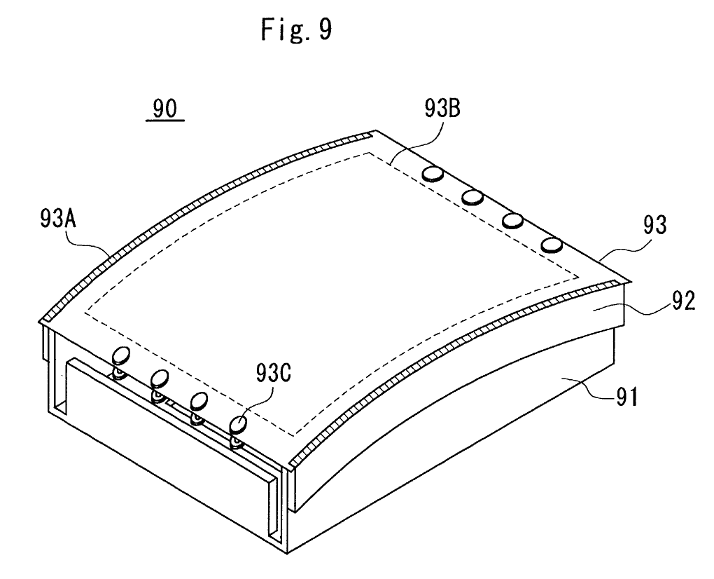

FIG. 9 is a perspective view of a shadow mask structure 90 according to a fifth embodiment of the present invention, In this drawing, the reference numeral 91 denotes a mask frame, 92 is a mask supporting body, 93 is a shadow mask, 93A are shadow mask welding points, 93B is a holed part of the shadow mask 93, and 93C are vibration-absorbing bodies.

The shadow mask 93 has tension applied to it from two long sides of the mask frame 91, via the mask supporting bodies 92. The mask supporting body 92 is made of Invar that is 3 mm thick, and the material and dimensions of the mask frame 91 and the shadow mask 93 are the same as in the shadow mask structure 10 of the first embodiment.

The construction, materials, dimension, and mounting method of the vibration-absorbing bodies 93C are the same as the vibration-absorbing bodies 12C of the shadow mask structure 10 of the first embodiment, and will, therefore, not be explicitly described herein. The vibration-absorbing mechanism of the shadow mask 93 by means of the vibration-absorbing bodies 93C, and the effect thereof is also the same as the case of the shadow mask structure 10 of the first embodiment and will, therefore, not be described herein.

In the shadow mask structure 10 of the first embodiment of the present invention, the shadow mask 12 is directly welded to the mask frame 11. In this case, the shadow mask 12 is made of Invar, which has a low coefficient of thermal expansion (approximately 1.2 ppm at room temperature), and the mask frame 11 is made of 13 chromium stainless steel, which has a coefficient of thermal expansion that is approximately ten times that of Invar. When a color CRT is in use, the electron beam is shot on to the shadow mask 12, so that the shadow mask 12 and the mask frame 11 temperature rises to a maximum of approximately 100° C. Therefore, a problem of alignment occurs because of the difference in coefficients of thermal expansion between the shadow mask 12 and mask frame 11, leading to a danger of distortion of the shadow mask 12.

In contrast to this, in the case of the shadow mask structure 90 of the fifth embodiment of the present invention, the shadow mask 93 is welded to the mask supporting body 92 which is made of the same material, Invar, so that there is no misalignment caused due to difference in thermal expansion between the shadow mask 93 and the mask supporting body 92. Therefore, there is no danger of distortion of the shadow mask 93, enabling the achievement of an image with stable color purity.

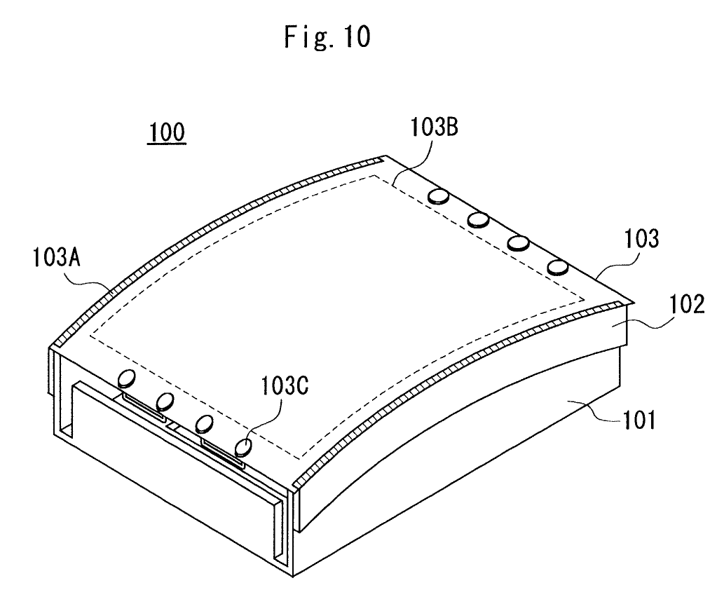

FIG. 10 is a perspective view of a shadow mask structure 100 according to a sixth embodiment of the present invention. In this drawing, the reference numeral 101 denotes a mask frame, 102 are mask supporting bodies, 103 is a shadow mask, 103A are shadow mask welding parts, 103B is a holed part of the shadow mask 103, and 103C are vibration-absorbing bodies.

The shadow mask 103 has tension applied to it from two long sides of the mask frame 101, via the mask supporting bodies 102. The mask supporting bodies 102 are made of Invar that is 3 mm thick, and the mask frame 101 and shadow mask 103 material and dimensions are the same as in the case of the shadow mask structure 10 of the first embodiment.

The construction, materials, dimension, and method of mounting the vibration-absorbing bodies 32C of the shadow mask structure 30 of the second embodiment, and will, therefore, not be explicitly described herein. The vibration-absorbing mechanism and the effect thereof of the shadow mask 103 by means of the vibration-absorbing bodies 103C is the same as the case of the shadow mask structure 10 of the first embodiment, and will, therefore, not be described herein.

The fact that there is no danger of distortion of the shadow mask 103 is the same as in the case of the shadow mask structure 90 of the fifth embodiment, and will, therefore, not be described herein.

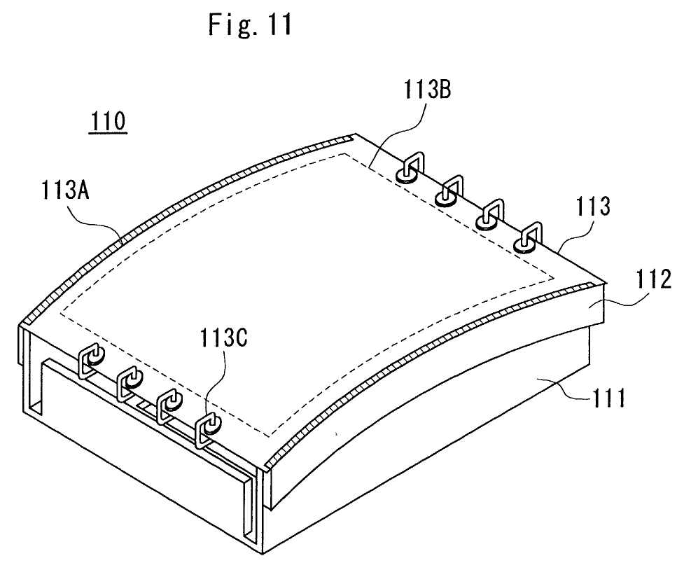

FIG. 11 is a perspective view of a shadow mask structure 110 according to a seventh embodiment of the present invention. In this drawing, the reference numeral 111 denotes a mask frame, 112 are mask supporting bodies, 113 is a shadow mask, 113A are shadow mask welding parts, 113B is a holed part of the shadow mask 113, and 113C are vibration-absorbing bodies.

The shadow mask 113 has tension applied to it from two long sides of the mask frame 111, via the mask supporting bodies 112. The mask supporting bodies 112 are made of Invar that is 3 mm thick, and the mask frame 111 and shadow mask 113 materials and dimensions are the same as in the shadow mask structure 10 of the first embodiment.

The construction, materials, dimensions, and method of mounting the vibration-absorbing bodies 113 are the same as the vibration-absorbing bodies 52C of the shadow mask structure 50 of the third embodiment and, therefore, will not be explicitly described herein.

The vibration-absorbing mechanism and the effect thereof of the shadow mask 113 by means of the vibration-absorbing bodies 113C are the same as in the shadow mask structure 10 of the first embodiment, and will, therefore, not be described herein.

The fact that there is no danger of distortion of the shadow mask 113 is the same as in the shadow mask structure 90 of the fifth embodiment, and will, therefore, not be described herein.

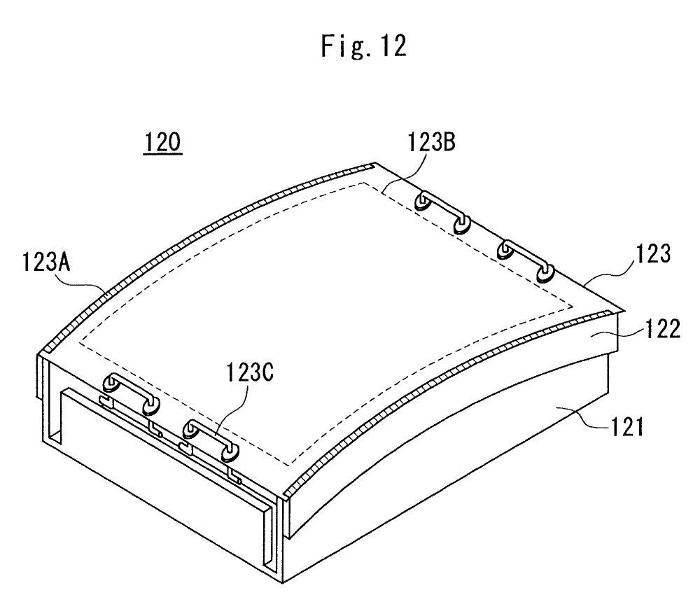

FIG. 12 is a perspective view of a shadow mask structure 120 according to an eight embodiment of the present invention. In this drawing, the reference numeral 121 denotes a mask frame, 122 are mask supporting bodies, 123 is a shadow mask, 123A are the shadow mask welding parts, 123B is the holed part of the shadow mask 123, and 123C are vibration-absorbing bodies.

The shadow mask 123 has tension applied to it from two long sides of the mask frame 121, via the mask supporting bodies 122. The mask supporting bodies 122 are made of Invar that is 3 mm thick, and the mask frame 121 and shadow mask 123 materials and dimensions are the same as in the shadow mask structure 10 of the first embodiment.

The construction, materials, dimensions, and method of mounting the vibration-absorbing bodies 123C are the same as the vibration-absorbing bodies 72C of the shadow mask structure 70 of the fourth embodiment, and will, therefore, not be explicitly described herein. The vibration-absorbing mechanism and the effect thereof of the shadow mask 123 by means of the vibration-absorbing bodies 123C are the same as the case of the shadow mask structure 10 of the first embodiment, and will, therefore, not be described herein.

The fact that there is no danger of distortion of the shadow mask 123 is the same as the case of the shadow mask structure 90 of the fifth embodiment, and will, therefore, not be described herein.

As described in detail above, a shadow mask structure according to the present invention has mounting holes provided in the non-holed part on two sides of the shadow mask to which tension is not applied, vibration-absorbing bodies being loosely engaged in these mounting holes. By virtue of this structure, the reduction in color purity caused by vibration of the shadow mask is reduced to a level that is no practical problem. By providing a shadow mask structure according to the present invention, it is possible to achieve a color CRT that features low cost, light weight, and good image quality.

What is claimed is:

1. A shadow mask structure comprising:
a mask frame with a substantially rectangular outer frame; and
a shadow mask that is substantially rectangular and is provided on said mask frame, and that ends portion of said shadow mask is provided onto a pair of long sides of said mask frame so that said mask is tensioned by said long sides,
wherein said mask is provided with mounting holes on at least one of the short-sides of said shadow mask, and vibration-absorbing bodies which are loosely engaged in said mounting holes, a part of the vibration-absorbing body that is in contact with the mounting holes comprising a bladed portion capable of completely covering said mounting hole.

2. A shadow mask structure according to claim 1, wherein said vibration-absorbing body is having a configuration in that at least two disk-shaped blade-like portions are provided at both ends of a substantially cylindrical body.

3. A shadow mask structure according to claim 1, wherein said vibration-absorbing body is substantially a U-shaped cylindrical body, with a substantially disc-shaped bladed portion provided at both ends of said U-shaped cylindrical body.

4. A shadow mask structure according to claim 1, wherein said vibration-absorbing body is substantially a ring-shaped cylindrical body with a bladed portion, wherein at an intermediate portion of said substantially ring-shaped cylindrical body there is a substantially disc-shaped bladed portion.

5. A shadow mask structure according to claim 1, wherein said vibration-absorbing body is opened gate-shaped with a bladed portion, wherein at an intermediate portion of said substantially opened gate-shaped cylinder, which is open at both ends, there is a bladed portion that is substantially disc-shaped.

6. A shadow mask structure according to claim 1, wherein the material of said mask frame is 13-chromium stainless steel, the material of said shadow mask is Invar, and the material of said vibration-absorbing body is 18-8 stainless steel.

7. A shadow mask structure comprising:
a mask frame having a substantially rectangular outer frame;
a substantially rectangular shadow mask;
a pair of mask-supporting bodies formed on a pair of longer sides of said mask frame, wherein each of long side portions of said shadow mask is contacted to each one of said pair of long side forming said mask supporting bodies so as to give tension to said shadow mask to form a shadow mask structure,
mounting holes provided at short sides in said shadow mask; and
a vibration-absorbing body loosely engaged in said mounting holes, said vibration-absorbing body being provided with a blade like portion at a part that comes into contact with said mounting holes, and said blade-like portions being capable of completely covering said mounting holes.

8. A shadow mask structure according to claim 7, wherein said vibration-absorbing body is having a configuration in that at least two disk-shaped blade-like portions are provided at both ends of a substantially cylindrical body.

9. A shadow mask structure according to claim7, wherein Said vibration-absorbing body is substantially a U-shaped cylindrical body, with a substantially disc-shaped bladed portion provided at both ends of said U-shaped cylindrical body.

10. A shadow mask structure according to claim 7, wherein said vibration-absorbing body is substantially ring-shaped cylindrical body with a blade, wherein at an intermediate portion of said substantially ring-shaped cylindrical body there is a substantially disc-shaped bladed portion.

11. A shadow mask structure according to claim 7, wherein said vibration-absorbing body is gate shaped with a blade, wherein intermediate in said substantially gate-shaped cylinder, which is open at both ends, there is a bladed portion that is substantially disc-shaped.

12. A shadow mask structure according to any one of claim 7 to claim 13, wherein the material of said mask frame is 13-chromium stainless steel, the material of said shadow mask is Invar, and the material of said vibration-absorbing body is 18-8 stainless steel.

13. A color CRT comprising a shadow mask structure according to any one of claim 1 to claim 12.
